(19) United States
(12) Patent Application Publication
(10) Pub. No.: US 2023/0322442 A1
(43) Pub. Date: Oct. 12, 2023

(54) Storage box with adjustable length and volume

(71) Applicant: Cheng Long, Shenzhen (CN)

(72) Inventor: Cheng Long, Shenzhen (CN)

(21) Appl. No.: 18/136,871

(22) Filed: Apr. 19, 2023

(30) Foreign Application Priority Data
Apr. 3, 2023 (CN) 202320751991.1

(51) Int. Cl. B65D 21/08

(52) U.S. Cl. CPC B65D 21/086

(57) ABSTRACT

A vehicle-mounted foldable storage box includes a storage box body which is sequentially provided with a left box body and a right box body. Elastic buckles are arranged on two opposite sides of the surface of the left box body. A clamping table is arranged at one end of the bottom of the elastic buckle. A sliding rail is arranged on the bottom surface of the left box body. A plurality of groups of teeth are transversely arranged on one side of the sliding rail.

### FIELD OF THE INVENTION

The invention relates to storage boxes and more particularly to a vehicle-mounted storage box structure with adjustable length and volume cavities.

### BACKGROUND OF THE INVENTION

The on-board storage box is a device for storing and placing articles in the car compartment. Many people will buy such products to expand the storage capacity in the car and facilitate long-distance travel.

However, many storage boxes or storage barrels are made of hard materials, so it is impossible to adjust the length or height of the storage boxes or storage barrels in real time, and it will occupy more space in the car during use, which is not practical. At present, there are storage boxes or storage barrels made of soft silica gel in the market, but they are not suitable for placing some heavy things, and this kind of products can only be accommodated by adjusting the height as a whole, but not by adjusting the length left and right, so the application scenarios are limited.

Thus, the need for improvement still exists.

### SUMMARY OF THE INVENTION

In order to overcome the defects of the prior art, an embodiment of the invention provides a vehicle-mounted storage box structure with adjustable length and volume cavity, so as to solve the problems raised in the background art.

In order to achieve the above purpose, the invention provides the following technical scheme: A vehicle-mounted storage box structure with adjustable length and volume cavity comprises a storage box body, and is characterized in that: The storage box body is sequentially provided with a left box body and a right box body from left to right.

Elastic buckles are arranged on two opposite sides of the surface of the left box body, a clamping table is arranged at one end of the bottom of the elastic buckle, a sliding rail is arranged on the bottom surface of the left box body, and a plurality of groups of teeth patterns I are transversely arranged on one side of the sliding rail.

The two sides of the surface of the right box body corresponding to the elastic buckle are provided with clamping grooves, one side of the clamping groove is provided with a limited clamping hole, and the bottom of the cavity of the right box body is provided with a chute at the position corresponding to the slide rail on the left box body.

The chute is matched with the slide rail on the left box body.

The bottom surface of the right box body is provided with a locking body.

The locking body comprises a mounting groove arranged vertically below one side of the sliding groove on the bottom surface of the right box body, a through hole arranged on the top inner wall of the mounting groove, the through hole penetrating the sliding groove, and a key body and a spring arranged in the mounting groove, one end of the spring is sleeved on the clamp post at the bottom of the key body, and the other end of the spring is sleeved on the clamp post at the bottom of the installation slot.

The key body is slidably connected with the installation groove.

One side surface of the key body is provided with a boss, and a plurality of groups of tooth patterns II are transversely arranged on the top of the boss, and the tooth patterns II pass through the matched through holes and are matched and meshed with the tooth patterns I on the slide rail.

The left box body is connected with the right box body in a sliding way through a slide rail and a chute.

By pressing the key body, the spring at the bottom of the key body retracts, and the second tooth pattern on the key body is separated from the first tooth pattern on the slide rail. At this time, the left box body can be pulled/pushed to the left/right, so that the length of the storage box body can be stretched, the volume cavity of the storage box body can be enlarged or the length of the storage box body can be shortened and the volume cavity of the storage box body can be reduced, so as to meet different usage scenarios of users.

Preferably, the elastic buckles are integrally injection-molded with the left box body, wherein the number of the elastic buckles is one or more groups.

Preferably, the inner wall of one side of the clamping groove and one end close to the limit clamping hole are designed to be inclined outwards, which is beneficial to clamping or sliding out of the clamping platform on the elastic buckle.

Preferably, the other end of the inner wall of one side of the card slot is designed at a right angle to prevent the card table on the elastic clip from sliding through the card slot. When the left box body is pushed to the right until the card table contacts the right angle end wall of the card slot, this is the minimum volume cavity and minimum length of the storage box main body.

Preferably, the limit clamping hole is matched with the clamping table on the elastic buckle, and when the left box body is pulled to the left until the clamping table on the elastic buckle is clamped into the limit clamping hole, it is the maximum volume cavity and the maximum length of the storage box body.

Preferably, the number of slide rails on the left box body is set to one or more groups, and it is matched with the number of chute on the right box body.

Preferably, the number of the locking bodies is set to one or more groups.

Preferably, the outer diameter width of the shell of the left box is smaller than the inner diameter width of the accommodating cavity of the right box, and the left box slides in the accommodating cavity of the matched right box.

Preferably, the locking body further comprises a cover plate, and the cover plate is fixed above the installation groove by screws or buckles.

Preferably, the heights of the left box body and the right box body are set to 5-30 cm.

The invention has following technical effects and advantages:

According to the invention, the slide rails and chutes are arranged on the left box body and the right box body; when in use, the left box body can be pulled/pushed to the left/right to realize the adjustment of the volume cavity size of the storage box body; moreover, the user can adjust the storage space of the storage box body for placing/storing articles at will according to actual scenes and needs; and meanwhile, the storage box body is more convenient to carry after being shortened in length, which is very practical.

The above and other objects, features and advantages of the invention will become apparent from the following detailed description taken with the accompanying drawings

### BRIEF DESCRIPTION OF THE DRAWINGS

FIG. 1 is a perspective view of a storage box body of the invention, viewed from top and unfolded to be ready for use;

FIG. 2 is an exploded view of FIG. 1 showing bottoms of the left box body and the right box body;

FIG. 3 is a perspective view of the storage box body, viewed from bottom and the cover plate removed;

FIG. 4 is a detailed view of the area in circle 4 in FIG. 3;

FIG. 5 is a perspective view of the right box body, viewed from bottom;

FIG. 6 is a perspective view of the key body;

FIG. 7A is a s perspective view of the left box body, viewed from bottom;

FIG. 7B is a s perspective view of the right box body, viewed from top; and

FIG. 8 is a perspective view of the storage box body, folded in a storage state.

### DETAILED DESCRIPTION OF THE INVENTION

In the following, the technical scheme in the embodiment of the invention will be clearly and completely described with reference to the attached drawings. Obviously, the described embodiment is only a part of the embodiment of the invention, but not the whole embodiment. Based on the embodiments in the invention, all other embodiments obtained by ordinary technicians in the field without creative labor belong to the scope of protection of the invention.

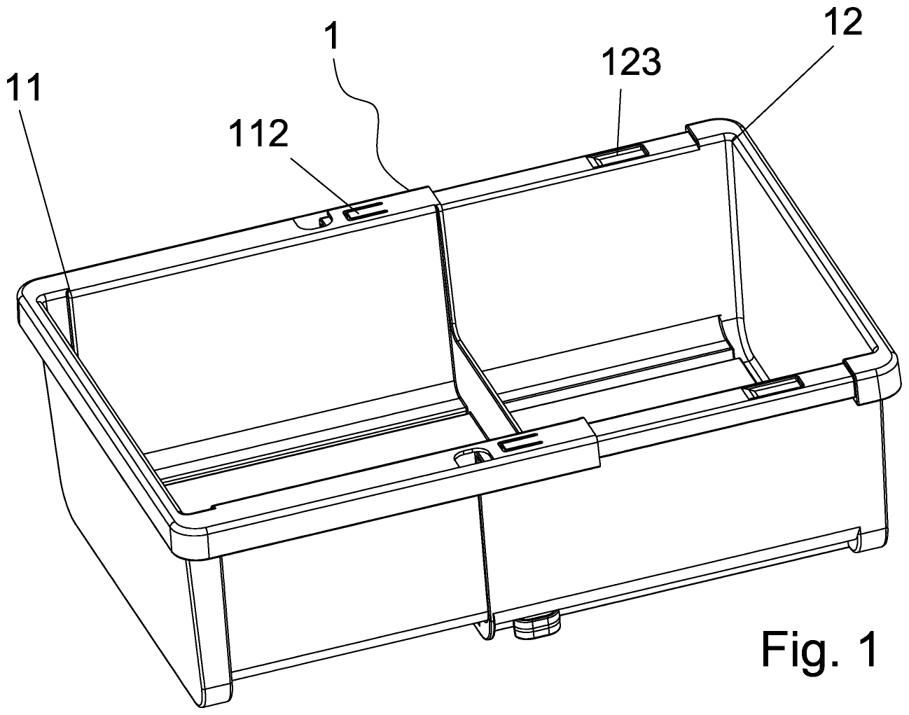

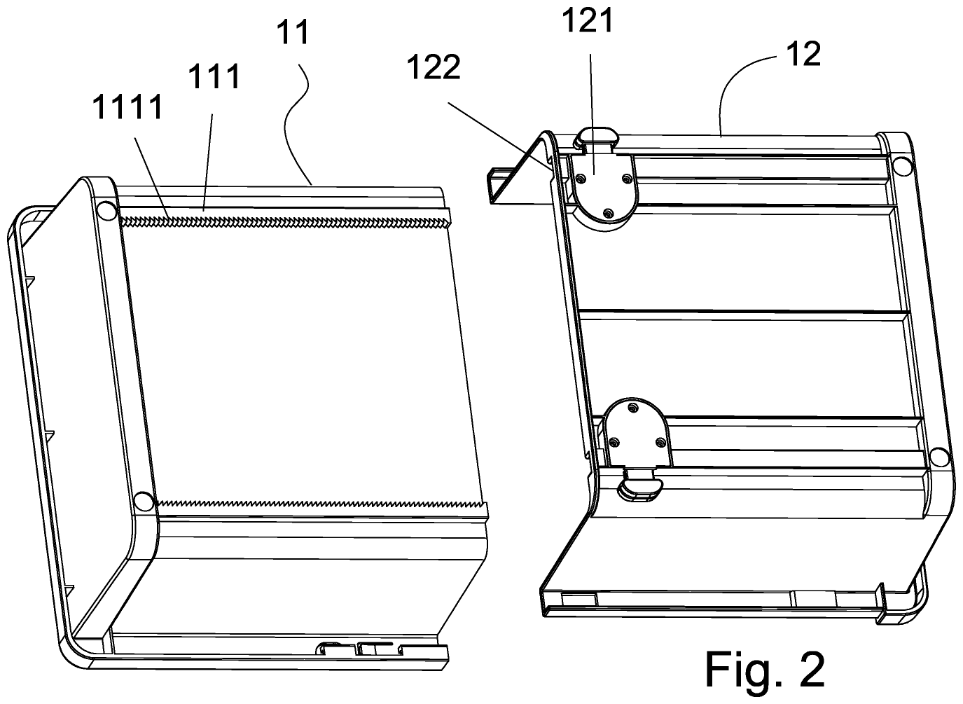

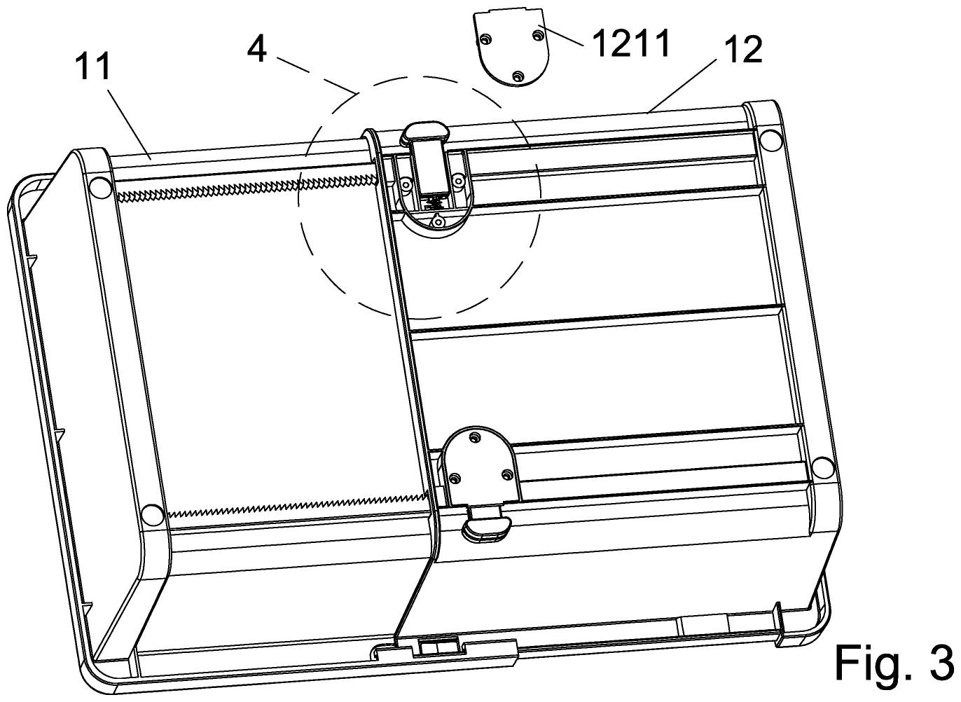

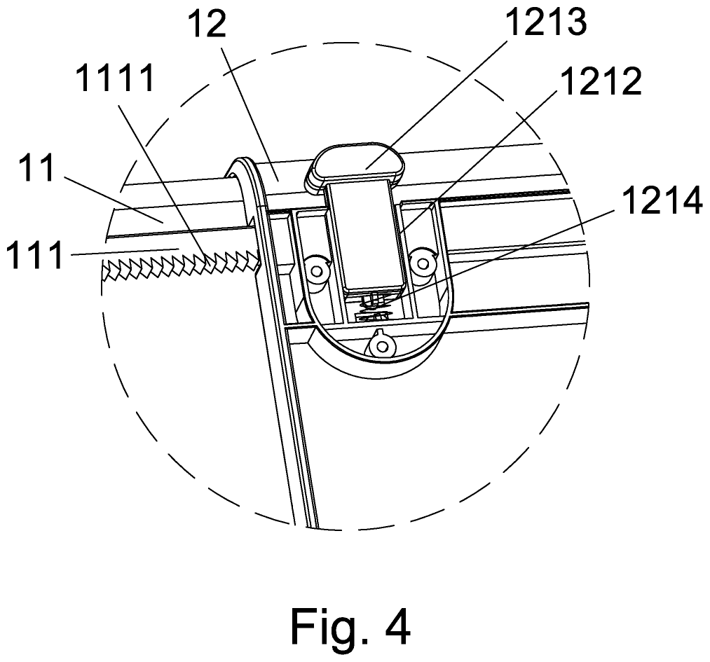

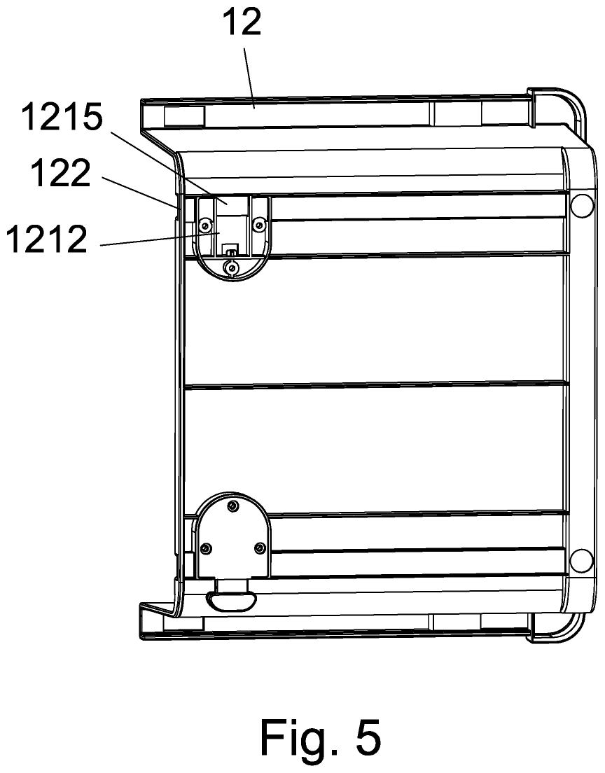

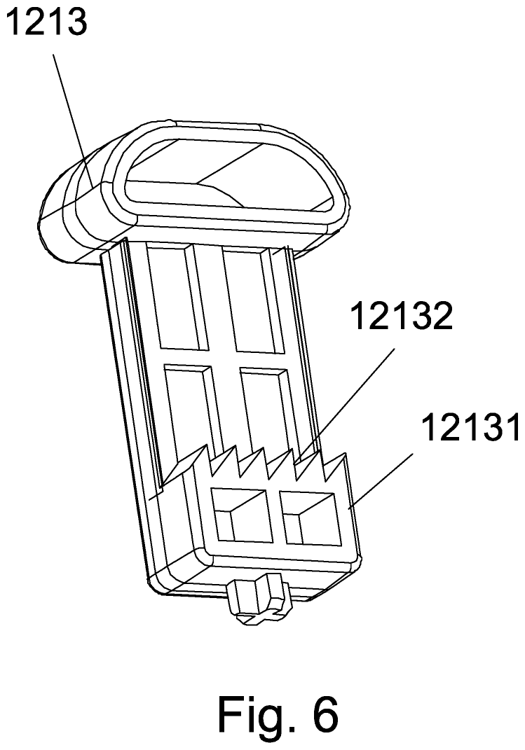

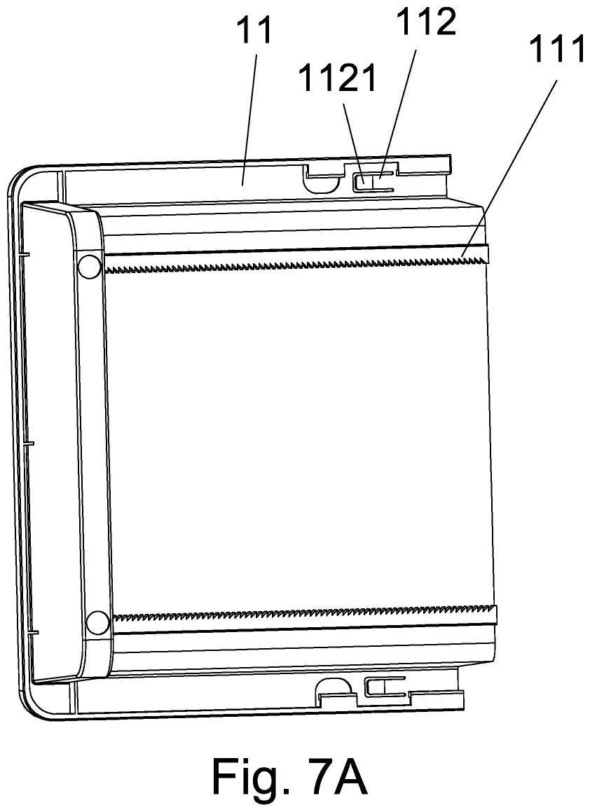

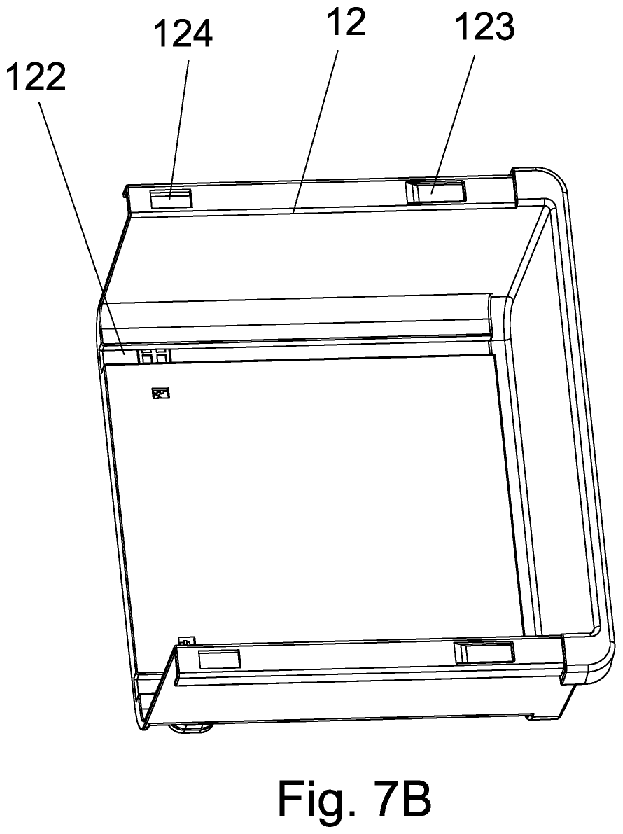

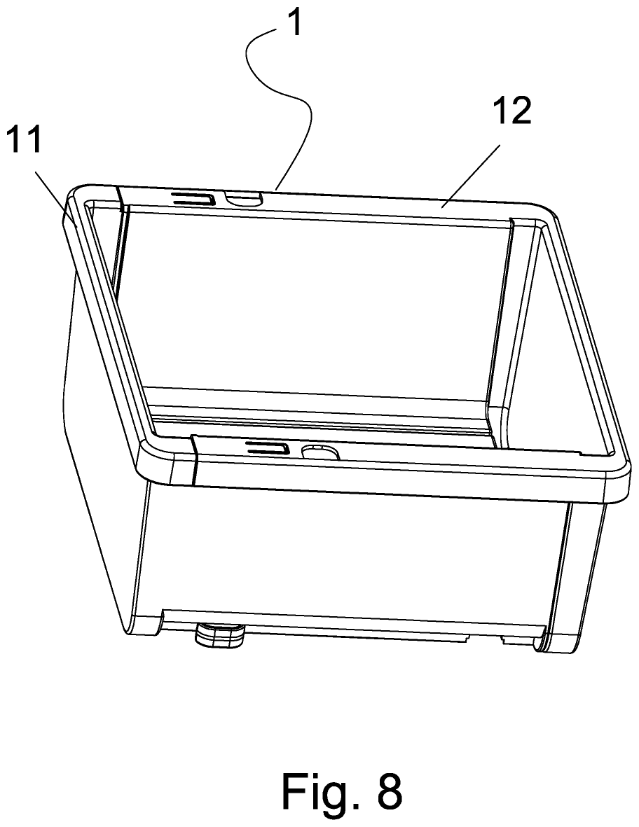

Referring to FIGS. 1-8, a vehicle-mounted storage box structure with adjustable length and volume cavity of the invention comprises a storage box body 1. The storage box body 1 is sequentially provided with a left box body 11 and a right box body 12 from left to right. Elastic buckles 112 are arranged on two opposite sides of the surface of the left box body 11, a clamping platform 1121 is arranged at one end of the bottom of the elastic buckles 112, a sliding rail 111 is arranged on the bottom surface of the left box body 11, and a plurality of groups of teeth 1111 are transversely arranged on one side of the sliding rail 111. Two sides of the surface of the right box body 12 corresponding to the elastic buckle 112 are provided with clamping grooves 123, one side of the clamping groove 123 is provided with a limited clamping hole 124, and the bottom of the cavity of the right box body 12 is provided with a chute 122 at a position corresponding to the slide rail 111 on the left box body 11. The chute 122 is adapted to the slide rail 111 on the left box body 11. The bottom surface of the right box body 12 is provided with two locking bodies 121.

The locking body 121 includes a mounting groove 1212 vertically arranged below the chute 122 side on the bottom surface of the right box body 12, and a through hole 1215 is arranged on the inner wall of the top side of the mounting groove 1212, and the through hole 1215 passes through the chute 122, and a key body 1213 and a spring 1214 are arranged in the mounting groove 1212. One end of the spring 1214 is sleeved on the post at the bottom of the key body 1213, and the other end of the spring 1214 is sleeved on the post at the bottom of the installation groove 1212. The key body 1213 is slidably connected with the mounting groove 1212. One side surface of the key body 1213 is provided with a boss 12131, and a plurality of groups of second teeth 12131 are transversely arranged on the top of the boss 12131, and the second teeth 12131 pass through the matched through hole 1215 to be matched and engaged with the first teeth 1111 on the slide rail 111. The left box body 11 is slidably connected with the right box body 12 through a slide rail 111 and a chute 122.

By pressing the key body 1213, the spring 1214 at the bottom of the key body 1213 retracts, and the second tooth pattern 12131 on the key body 1213 disengages from the first tooth pattern 1111 on the slide rail 111. At this time, the left box body 11 can be pulled/pushed to the left/right, so as to stretch the length of the storage box body 1 and expand the volume cavity of the storage box body 1 or shorten the length of the storage box body 1 and reduce the volume cavity of the storage box body 1.

In some embodiments, the elastic buckles 112 are integrally injection-molded with the left box body 11, wherein the number of the elastic buckles 112 is one or more groups. Further, the inner wall of one side of the clamping groove 123 and the end close to the limit clamping hole 124 are designed to be inclined outward, which is beneficial to the clamping platform 1121 on the elastic buckle 112 to be clamped in/out. Further, the other end of the inner wall of one side of the card slot 123 is designed at a right angle to prevent the card platform 1121 on the elastic buckle 112 from slipping through the card slot 123. When the left box body 11 is pushed to the right until the card platform 1121 contacts the right-angled end wall of the card slot 123, it is the minimum volume cavity and the minimum length of the storage box body 1. Further, the limit clamping hole 124 is adapted to the clamping platform 1121 on the elastic buckle 112. When the left box body 11 is pulled to the left until the clamping platform 1121 on the elastic buckle 112 is clamped into the limit clamping hole 124, it is the maximum volume cavity and the maximum length of the storage box body 1. Further, the number of slide rails 111 on the left box 11 is set to one or more groups, and it matches the number of slide grooves 122 on the right box 12. Further, the number of locking bodies 121 is set to one or more groups. Further, the outer diameter width of the left box 11 is smaller than the inner diameter width of the right box 12, and the left box 11 slides in the matched right box 12. Furthermore, the locking body 121 also includes a cover plate 1211, and the cover plate 1211 is fixed above the mounting groove 212 by screws or buckles. Specifically, the heights of the left box 11 and the right box 12 are set to 5-30 cm.

The work principle of the invention is as follows:

The storage box body 1 of the invention is mainly assembled by a left box body 11 and a right box body 12, wherein the left box body 11 is provided with a slide rail 111, and the right box body 12 is provided with a chute 122; the slide rail 111 on the left box body 11 slides left/right in the chute 122 on the right box body 12 to realize the increase and decrease of the volume cavity of the storage box body 1, and the length of the storage box body 1 also changes with the adjustment. When the left box body 11 is pushed to the right until the clamping platform 1121 contacts the right-angled end wall of the clamping slot 123, it is the minimum volume cavity and the minimum length of the storage box body 1, which is convenient for storage and carrying. When the left box body 11 is pulled to the left until the card 1121 on the elastic buckle 112 is caught in the limit hole 124, this is the maximum volume cavity and the maximum length of the storage box body 1, and more articles can be placed and accommodated in the storage box body 1, which is very practical.

When in use, by pressing the key body 1213, the key body 1213 slides downward in the mounting groove 1212, and at the same time, the spring 1214 at the bottom of the key body 1213 retracts, so that the second tooth pattern 12131 on the key body 1213 disengages from the first tooth pattern 1111 on the slide rail 111. At this time, the left box body 11 can be pulled/pushed left/right. When the left box body 11 is adjusted to a suitable position, the key body 1213 is released, and the elastic force generated by the reset of the spring 1214 pushes the tooth pattern II 12131 of the key body 1213 into the tooth pattern I 1111 on the slide rail 111. The tooth pattern II 12131 meshes with the tooth pattern I 1111, while fixing the left box body 11, Thereby extending the length of the storage box main body 1 and expanding the volumetric cavity of the storage box main body 1, or shortening the length of the storage box main body 1 and reducing the volumetric cavity of the storage box main body 1, to meet different usage scenarios of users.

It should be noted that the storage box main body 1 can be placed in the gap behind the front seat in the car after storing the articles, and will not occupy the extra space in the aisle in the car. The storage box main body 1 can also be vertically installed in the middle of the rear air outlet and the rear seat in the car. When installing, first press the button body 1213, pull the left box body 11, and then release the button body 1213 after adjusting the length and size of the storage box main body 1 adapted to the installation place. The left box body 11 and the right box body 12 are engaged and fixed with each other through the second tooth pattern 12131 and the first tooth pattern 1111 on the key body 1213, thus completing the installation of the storage box body 1, which is very convenient to use.

While the invention has been described in terms of preferred embodiments, those skilled in the art will recognize that the invention can be practiced with modifications within the spirit and scope of the appended claims.

What is claimed is:

1. A vehicle-mounted storage box structure, comprising:
a storage box main body;
wherein the storage box main body is sequentially provided with a left box body and a right box body from left to right;
wherein elastic buckles are arranged on two sides opposite to the surface of the left box body, a clamping table is arranged at one end of the bottom of the elastic buckle, a sliding rail is arranged on the bottom surface of the left box body, and a plurality of groups of tooth patterns are transversely arranged on one side of the sliding rail;
wherein the surface of the right box body is provided with clamping slots on both sides corresponding to the elastic snap fastener, and one side of the clamping slot is provided with a limited clamping hole;
wherein the bottom of the cavity of the right box body is provided with a sliding slot corresponding to the slide rail on the left box body;
wherein the chute is matched with the slide rail on the left box body;
wherein the bottom surface of the right box body is provided with two locking bodies;
wherein each of the locking bodies comprise a mounting groove arranged vertically below one side of the sliding groove on the bottom surface of the right box body, a through hole arranged on the top inner wall of the mounting groove, the through hole penetrating the sliding groove, and a key body and a spring arranged in the mounting groove, one end of the spring is sleeved on the clamp post at the bottom of the key body, and the other end of the spring is sleeved on the clamp post at the bottom of the installation slot;
wherein the key body is slidably connected with the installation groove;
wherein one side surface of the key body is provided with a boss, and a plurality of groups of second teeth are transversely arranged on the top of the boss, and the second teeth pass through the matched through hole and are matched and meshed with the first teeth on the slide rail;
wherein the left box body is slidably connected with the right box body through a slide rail and a chute; and
wherein by pressing the key body, the spring at the bottom of the key body retracts, and the second tooth pattern on the key body is separated from the first tooth pattern on the slide rail, at this time, the left box body can be pulled or pushed to the left or right, so that the length of the storage box body can be stretched and the volume cavity of the storage box body can be enlarged or the length of the storage box body can be shortened and the volume cavity of the storage box body can be reduced, so as to meet different use scenarios of users.

2. The vehicle-mounted storage box structure of claim 1, wherein the elastic buckles are integrally injection-molded with the left box body, wherein the number of the elastic buckles is one or more groups.

3. The vehicle-mounted storage box structure of claim 1, wherein the inner wall of one side of the clamping groove and one end close to the limit clamping hole are designed to be inclined outwards, which is beneficial to clamping or sliding out of the clamping platform on the elastic buckle.

4. The vehicle-mounted storage box structure of claim 1, wherein the other end of the inner wall of one side of the card slot is designed at a right angle to prevent the card table on the elastic clip from sliding through the card slot, when the left box body is pushed to the right until the card table contacts the right angle end wall of the card slot, this is the minimum volume cavity and minimum length of the storage box main body.

5. The vehicle-mounted storage box structure of claim 1, wherein the limit clamping hole is matched with the clamping table on the elastic buckle, and when the left box body is pulled to the left until the clamping table on the elastic buckle is clamped into the limit clamping hole, it is the maximum volume cavity and the maximum length of the storage box body.

6. The vehicle-mounted storage box structure of claim 1, wherein the number of slide rails on the left box body is set to one or more groups, and it is matched with the number of chute on the right box body.

7. The vehicle-mounted storage box structure of claim 1, wherein the number of the locking bodies is set to one or more groups.

8. The vehicle-mounted storage box structure of claim 1, wherein the outer diameter width of the shell of the left box is smaller than the inner diameter width of the accommodating cavity of the right box, and the left box slides in the accommodating cavity of the matched right box.

9. The vehicle-mounted storage box structure of claim 1, wherein the locking body further comprises a cover plate, and the cover plate is fixed above the installation groove by screws or buckles.

10. The vehicle-mounted storage box structure of claim 1, wherein the heights of the left box body and the right box body are set to 5-30 cm.
